(19) United States
(12) Patent Application Publication
(10) Pub. No.: US 2004/0121675 A1
(43) Pub. Date: Jun. 24, 2004

(54) Treatment of substrates for improving ink adhesion to the substrates

(75) Inventors: Hue Scott Snowden, Woodstock, GA (US); Lavada Campbell Boggs, Marietta, GA (US); Ali Yahiaoui, Roswell, GA (US)

Correspondence Address: KIMBERLY-CLARK WORLDWIDE, INC., 401 NORTH LAKE STREET, NEENAH, WI, 54956

(73) Assignee: Kimberly-Clark Worklwide, Inc.

(21) Appl. No.: 10/328,452

(22) Filed: Dec. 23, 2002

(51) Int. Cl. B32B 3/00

(52) U.S. Cl. 442/59; 442/327

(57) ABSTRACT

Printed substrates, ink compositions and methods for treating substrates to improve the adhesion of an ink composition to a hydrophobic substrate are provided. The ink compositions and printed substrates include a polysaccharide, a modified polysaccharide, a derivative of a polysaccharide, or a derivative of a modified polysaccharide. The method involves contacting at least a portion of a hydrophobic substrate with a composition that comprises a polysaccharide, a modified polysaccharide, a derivative of a polysaccharide, or a derivative of a modified polysaccharide; and then printing a pattern or other indicia on at least a portion of the portion of the hydrophobic substrate that was contacted with a polysaccharide, a modified polysaccharide, a derivative of a polysaccharide, or a derivative of a modified polysaccharide using an ink composition.

### FIELD

The present invention is directed to printed nonwoven fabrics, films, foams and to the treatment of nonwoven fabrics, films and foams to improve the adhesion of ink to the nonwoven fabrics, films and foams.

### BACKGROUND

Polymers are used extensively to make a variety of products which include blown and cast films, extruded sheets, injection molded articles, foams, blow molded articles, extruded pipe, monofilaments, fibers and nonwoven fabrics. Polymers that are used to form theses, such as polyolefins, are naturally hydrophobic, and for many uses hydrophobicity is a disadvantage. Polyolefins, such as polyethylene and polypropylene, are used to manufacture polymeric fabrics which are employed in the construction of such disposable absorbent articles as diapers, feminine care products, incontinence products, training pants, wipes, and so forth. Such polymeric fabrics often are nonwoven fabrics prepared by, for example, such processes as melt-blowing, carding, coforming and spunbonding. It would be desirable to provide a method of improving the printability of polymeric substrates such as nonwoven fabrics made from polyolefin fibers.

Absorbent articles, especially personal care absorbent articles, such as diapers, training pants, and swimming pants typically include an outercover that made from a nonwoven polymeric fabric. The outercover of diapers, training pants, and swimming pants are difficult to print on in a fast and economical manner that is amenable to efficient machine production. More particularly, it is difficult to get good ink transfer and good ink adhesion to such hydrophobic substrates. Accordingly, there is a need to improve transfer and/or adhesion of inks to outercovers on diapers, training pants, swimming pants and other products that incorporate hydrophobic substrates.

### Test Method

A crock test method was used to measure whether the combinations of treated nonwovens and inks had sufficient abrasion resistance. The crock test method was based upon American Association of Textile Chemists and Colorists (AATCC) Test Method 116-1983, which is incorporated herein in its entirety with a few modifications. The AATCC Test Method uses a device called a Rotary Vertical Crockmeter to rub a piece of test fabric against the sample specimen. This modified crock test method used a device called at Sutherland Rub Tester as an alternative to the Crockmeter. The Sutherland Rub Tester is used in the printing industry to evaluate the resistance of inks and coatings on printed substrates. It has a broader test area than the crockmeter. The test head is 2-inches×4-inches for an eight square inch test area. The test head is moved laterally over the test specimen in a shallow arc pattern. Various weights are available to alter the pressure on the test surface and the number of test “strokes” is variable. This test method used a 4.0 pound weight and 50 rub strokes. The test specimen can be abraded against any material that can be readily attached to the opposing surface of the tester.

Any transfer of colorant is qualitatively rated from one to five against a standard scale. A five is equivalent to the absence of transfer and a one is equivalent to an extreme amount of colorant transfer. The primary difference between the test method used in the following examples and the AATCC method was a quantitative method of assigning a colorfastness value. The latter was achieved by using a Colorimeter or a Spectrophotometer to assign a measurement of total colorant transfer. This measured value is known as “Delta E”. An equation was then developed to convert the Delta E value to into a one to five value equivalent to the AATCC colorfastness scale.

According to the test procedure, test specimens were analyzed for the CIELAB color difference which is expressed as E. The E was then converted to a number between 1 and 5 using the following equation: C.R.=A exp.(−B) where A=5.063244 and B=0.059532(ΔE) if E is less than 12, or A=4.0561216 and B=0.041218 (ΔE) if E is greater than 12. This number C.R. is the crockfastness rating. A rating of 1 corresponds to a low or bad result, while a rating of 5 is the highest possible test result, and this value would indicate that essentially no color was rubbed off the sample material.

Another change in the test for use with the present invention was that the amount of color transferred to the test specimen was measured using an X-Rite Spectrodensitometer, instead of the AATCC Chromatic Transference Scale or grade scale measuring device. With the Colorimeter or Spectrodensitometer, greater objectivity in evaluating the results was possible due to less operator dependence, and it was also possible to achieve higher efficiency and consistency for on-line quality assurance. The Hunter Colorimeter Model D25 is manufactured by Hunter Associates Laboratory, Inc., of Reston, Va. The X-Rite 938 Spectrodensitometer is manufactured by X-Rite, Inc., of Grandville, Mich. The crock test was performed using AATCC crock meter Model CM-6 supplied by Atlas Electric Device Company of Chicago, Ill.

Equipment and Materials Used

1. Sutherland Rub Tester. Sharp edges on the vertical rod were filed to reduce abrasion of nonwoven materials.

2. Crockmeter cloth, standard 4-inch by 8-inch (approximately 102 millimeter by 203 millimeter) test squares.

3. Hunter Colorimeter Model D25 manufactured by Hunter Associates Laboratory, Inc., of Reston, Va., or an X-Rite Spectrodensitometer manufactured by X-Rite, Inc., of Grandville, Mich.

4. X-Rite Spectrophotometer.

5. Distilled water.

6. Saline solution—S/P Certified Blood Bank Saline, Catalogue No. B3158-1, 8.5 grams sodium chloride per liter of reagent grade water.

7. Paper Cutter, standard 12-inch by 12 inch (305 mm×305 mm) minimum cutting area, obtained from Testing Machines, Inc., Amityville, N.Y.

8. Analytical Balance, readable to 0.01 gram (Mettler PE 1600).

9. Room with standard conditions atmosphere: temperature=23±1° C. (73.4±1.8° F.) and relative humidity=50±2 percent. Testing outside the specified limits for temperature and humidity may not yield valid results.

Specimen Preparation

The test specimens were a spunbond polypropylene web having a basis weight between about 27 grams per square meter (gsm). The test specimens were cut exactly 2 inches wide by 5.5 inches long in the machine direction of the web, unless otherwise noted, with the test area centered on the square.

Testing Procedure

1. Cut samples exactly 2 inches wide by 5.5 inches long in the machine direction of the substrate unless otherwise noted in the special instructions.

2. Adhere sample to 4 pound weight by placing the sample to be tested (matching long side to long side) on the weight and taping the excess with 610 tape. Be sure that the sample is taught and the printed side of material is to be facing out when taped on to the weight.

3. Label a white 4-inch×8-inch cotton sheet with the individual sample information. If sample is to be tested wet see instructions below.

4. Place the white cotton sheet lengthwise parallel to the direction of the rub. Tape both ends of the white sheet to the counter or lab bench using 610 tape making sure that the sheet is taught.

5. Place the weight (4.0 pounds) and sample on the rub tester arm.

6. Set the rub tester for 100 passes which is 50 cycles.

7. Start the rub tester and wait for the tester to stop.

8. When the rub test for the sample is completed, staple the sample to the white cotton cloth with the sample behind the cloth.

9. Once the rub testing for a batch of samples is completed Spectrophotometer reading may begin.

10. A white standard must be read in each new day of Spectrophotometer reading or more frequently if noted in special instructions.

11. Be sure that the data mode for the printout is set to Difference mode and that it is D50/10° and Lab.

12. Read each sample, reading the area that appears to have the most amount of ink transfer, beginning with the white standard if necessary then proceeding through the batch.

13. Number the sample during the reading consecutively from 1 to the end with number 1 being the white standard if necessary. These numbers should match the printout.

14. After reading all of the samples with the Spectrophotometer, print out the report and label the report with sample information. (i.e. White standard and Sample identity.)

Optional Wet Sample Testing:

1. Weigh the Crockmeter cloth standard. Record the weight.

2. Thoroughly wet out the material with the appropriate solution.

3. Bring the wet pick-up to 65+/−0.5 percent (This is done by wringing or blotting the excess solution from the material, weighing the material and calculating the percent pick-up. Calculate: wet weight minus dry weight divided by dry weight times 100=percent pick-up). To prevent evaporation, prepare one wet cloth at a time for testing.

4. Proceed with Steps 4 through 14.

Evaluation

The next step is the second modification to the AATCC test procedure, as earlier described above. The second modification is that the amount of color transferred to the test specimen was measured using a Hunter Colorimeter and/or an X-Rite Spectrodensitometer, instead of the AATCC Chromatic Transference Scale or a grade scale measuring device. As earlier described, E is then obtained and converted to a crockfastness rating between 1 and 5 using the equation set forth above.

Each specific ink formulation was tested 30 times with 30 test specimens. The average was determined by individually calculating the crockfastness rating for each of the 30 test specimens, summing the 30 crockfastness ratings, and then dividing by 30 to get the average wet crockfastness rating. The ink formulation was a PYROFLEX flexographic ink formulation obtained from Bemis Company, Inc, of Minneapolis, Minn.

### SUMMARY OF THE INVENTION

The present invention provides a printed polymeric substrate that includes: a polymeric substrate; a coating or other surface treatment on at least a portion of the polymeric substrate, the coating comprising at least one of a polysaccharide, a modified polysaccharide, a derivative of a polysaccharide, or a derivative of a modified polysaccharide; and a pattern or other indicia comprising an ink composition printed on at least a portion of the portion of the polymeric substrate that is coated with at least one of a polysaccharide, a modified polysaccharide, a derivative of a polysaccharide, or a derivative of a modified polysaccharide. The printed polymeric substrate can be a hydrophobic, polymeric substrate, for example a nonwoven substrate, a film or a foam substrate and may include hydrophobic fibers. The polysaccharide, the modified polysaccharide, the derivative of a polysaccharide, or the derivative of a modified polysaccharide may be a cellulosic, a modified cellulose ethers or a modified cellulose ester, for example carboxymethyl cellulose, hydroxypropyl cellulose, methylhydroxypropyl cellulose, hydroxyethyl cellulose, methylhydroxyethyl cellulose, and ethylhydroxyethyl cellulose. The ink composition may be a conventional ink formulation and can be selected by persons of skill in the art based on the compatibility of the ink composition with the substrate to be printed and the printing surface that transfers the ink to the printed surface. The ink formulation may further include a polysaccharide, a modified polysaccharide, a derivative of a polysaccharide, or a derivative of a modified polysaccharide that may be the same polysaccharide, a modified polysaccharide, a derivative of a polysaccharide, or a derivative of a modified polysaccharide as that of the treatment composition to further improve transfer and/or adhesion. The ink composition may include less than 50 weight percent of water may include methanol, ethanol, 1-propanol, 2-propanol, 1-butanol, 2-butanol or another alcohol. In a desirable embodiment, the present invention provides a printed nonwoven fabric that includes a large portion of polyolefin fibers or polyester fibers or a mixture thereof. The printed polymer substrate may be a component of a protective or other type of garment, a medical apparel article, a heath care article, a surgical drape or other medical curtain, a sheet or drape, a car cover, a pillow cover, an outercover for a diaper, training pants, swimming pants, an incontinence garment and so forth.

In another embodiment, the present invention provides a method of improving the adhesion of an ink composition to a hydrophobic substrate, the method includes: contacting at least a portion of a hydrophobic substrate with a composition that comprises at least one of a polysaccharide, a modified polysaccharide, a derivative of a polysaccharide, or a derivative of a modified polysaccharide; and printing a pattern or other indicia on at least a portion of the portion of the hydrophobic substrate that was contacted with a polysaccharide, a modified polysaccharide, a derivative of a polysaccharide, or a derivative of a modified polysaccharide using an ink composition. The treatment composition may further include water and may also further include one or more alcohols. The treatment composition may include less than about 10 percent by weight of a polysaccharide, a modified polysaccharide, a derivative of a polysaccharide, a derivative of a modified polysaccharide or a combination thereof relative to the weight of the treatment composition; less than about 5 percent by weight of a polysaccharide, a modified polysaccharide, a derivative of a polysaccharide, a derivative of a modified polysaccharide or a combination thereof relative to the weight of the treatment composition; less than about 1 percent by weight of a polysaccharide, a modified polysaccharide, a derivative of a polysaccharide, a derivative of a modified polysaccharide or a mixture thereof relative to the weight of the treatment composition; less than about 0.5 percent by weight of a polysaccharide, a modified polysaccharide, a derivative of a polysaccharide, a derivative of a modified polysaccharide or a mixture thereof relative to the weight of the treatment composition; and even less than about 0.3 percent by weight of a polysaccharide, a modified polysaccharide, a derivative of a polysaccharide, a derivative of a modified polysaccharide or a mixture thereof relative to the weight of the coating composition. The method may further include exposing the hydrophobic substrate to corona discharge, plasma or flame treatment prior to contacting the substrate with a polysaccharide, a modified polysaccharide, a derivative of a polysaccharide, or a derivative of a modified polysaccharide. Again, the polymeric substrate may be a hydrophobic film, foam or nonwoven substrate, such as a spunbonded nonwoven fabric and the polysaccharide, the modified polysaccharide, the derivative of a polysaccharide, or the derivative of a modified polysaccharide may be a cellulosic, a modified cellulose ether or a modified cellulose ester, such as carboxymethyl cellulose, hydroxypropyl cellulose, methylhydroxypropyl cellulose, hydroxyethyl cellulose, methylhydroxyethyl cellulose, or ethylhydroxyethyl cellulose.

The ink composition may also include at least one of a polysaccharide, a modified polysaccharide, a derivative of a polysaccharide, or a derivative of a modified polysaccharide. The ink composition may include less than about 10, less than about 5, less than about 1 and even less than about 0.5 weight percent of water and is desirably a non-aqueous ink composition that includes methanol, ethanol, 1-propanol, 2-propanol, 1-butanol, 2-butanol or another alcohol.

In yet another embodiment, the present invention provides method of improving the adhesion of an ink composition to a hydrophobic, spunbonded nonwoven substrate, the method including: forming a hydrophobic, spunbonded nonwoven substrate; contacting at least a portion of the hydrophobic, spunbonded nonwoven substrate with a treatment composition that comprises an alcohol and less than about 1 weight percent of a polysaccharide, a modified polysaccharide, a derivative of a polysaccharide, or a derivative of a modified polysaccharide; and printing a pattern or other indicia on at least a portion of the portion of the hydrophobic, spunbonded nonwoven substrate that was contacted with a polysaccharide, a modified polysaccharide, a derivative of a polysaccharide, or a derivative of a modified polysaccharide.

In yet another embodiment, the present invention provides an ink composition that includes a polysaccharide, a modified polysaccharide, a derivative of a polysaccharide, or a derivative of a modified polysaccharide. The polysaccharide, the modified polysaccharide, the derivative of a polysaccharide, and the derivative of a modified polysaccharide may be selected from cellulosics, modified cellulose ethers and modified cellulose esters, such as water-soluble cellulose derivatives and high molecular weight, water-soluble cellulose derivatives. For example, the polysaccharide, the modified polysaccharide, the derivative of a polysaccharide, or the derivative of a modified polysaccharide may be carboxymethyl cellulose, hydroxypropyl cellulose, methylhydroxypropyl cellulose, hydroxyethyl cellulose, methylhydroxyethyl cellulose, and ethylhydroxyethyl cellulose. The ink composition may include less than about 10 weight percent of water, less than about 5 weight percent, less than about 1 weight percent and even less than about 0.5 weight percent of water. The ink composition may further include a pigment and nitrocellulose, a polyurethane, and/or a polyamide.

### BRIEF DESCRIPTION OF THE DRAWINGS

FIG. 1 illustrates an exemplary process for application of a treatment composition to a substrate.

FIG. 2 illustrates an exemplary dip and squeeze method of applying a treatment composition to a nonwoven fabric.

FIG. 3 schematically illustrates an exemplary foam treatment application system that provides zoned application.

FIG. 4 illustrates an exemplary zoned treatment application apparatus and system.

FIG. 5 is perspective view of an exemplary training pant.

FIG. 6 is an exploded cross-sectional view of FIG. 5 taken along line 6-6.

### DETAILED DESCRIPTION

Nonwoven fabrics, films, and foams are useful as components of absorbent products, personal care products, and health care products such as protective garments, other medical apparel, outercovers for diapers, outercovers for training pants, outercovers for swimming pants and so forth. Nonwoven fabrics, films, foams and other components of such disposable products are frequently made of or from synthetic polymers, particularly polyolefins such as polypropylene and polyethylene. Synthetic polymers, such as polyolefins are hydrophobic and difficult to print on. The present invention provides printed nonwoven fabrics, films, and foams and also provides compositions and methods for treating such hydrophobic substrates to improve the printability of ink on the hydrophobic substrates.

As used herein, the term “hydrophobic substrate” is meant to include any shaped article, provided it is composed, in whole or in part, of a hydrophobic polymer and the term “porous hydrophobic substrate” is meant to include any substrate, provided it is porous and composed, in whole or in part, of a hydrophobic polymer. For example, the hydrophobic substrate may be a sheet-like material, such as a sheet of a foamed material. The hydrophobic substrate also may be a fibrous fabric, such as fibrillated film or a woven or nonwoven web or fabric. Nonwoven fabrics include, but are not limited to, a meltblown fabric, a spunbonded fabric, a carded fabric or an airlaid fabric. The hydrophobic substrate also may be a laminate of two or more layers of a sheet-like material. For example, the layers may be independently selected from the group consisting of meltblown fabrics and spunbonded fabrics. However, other sheet-like materials such as films or foams may be used in addition to, or instead of, meltblown and spunbonded fabrics. In addition, the layers of the laminate may be prepared from the same hydrophobic polymer or different hydrophobic polymers.

The substrate may be a hydrophobic nonwoven fabric that includes synthetic fibers, particularly polyolefin fibers. According to the present invention, a nonwoven fabric is contacted with a treatment composition that includes one or more polysaccharides, modified polysaccharides, derivatives of polysaccharides, or derivatives of modified polysaccharides. For example, a nonwoven fabric made from hydrophobic synthetic fibers, such as polypropylene fibers, is contacted with an aqueous or nonaqueous composition that includes a cellulosic to provide a more printable polyolefin nonwoven fabric. The polyolefin fibers that form the fabric may include polyethylene and/or polypropylene fibers and fibers produced from compositions and blends that include a polyethylene and/or a polypropylene resin and can be produced by various known methods.

Methods of making films, foams and nonwoven fabrics from synthetic polymers, are well known. Films, foams, nonwoven fabrics and other substrates generally may be prepared by any known means. As a practical matter, however, the films, nonwoven fabrics and the fibers that make up nonwoven fabrics usually will be prepared by a melt-30 extrusion process and formed into a film or fibrous fabric, such as a nonwoven fabric. The term “melt-extrusion process” as applied to a nonwoven fabric is meant to include a nonwoven fabric prepared by any melt-extrusion process for forming a nonwoven fabric in which melt-extrusion to form fibers is followed by fabric formation, typically concurrently, on a porous support. The term includes, among others, such well-known processes as meltblowing, coforming, spunbonding, and so forth. By way of illustration only, such processes are exemplified by the following references: meltblowing references include, by way of example, U.S. Pat. No. 3,016,599 to R. W. Perry, Jr., U.S. Pat. No. 3,704,198 to J. S. Prentice, U.S. Pat. No. 3,755,527 to J. P. Keller et al., U.S. Pat. No. 3,849,241 to R. R. Buntin et al., U.S. Pat. No. 3,978,185 to R. R. Buntin et al., and U.S. Pat. No. 4,663,220 to T. J. Wisneski et al. See, also, V. A. Wente, “Superfine Thermoplastic Fibers”, Industrial and Engineering Chemistry, Vol. 48, No. 8, pp. 1342-1346 (1956); V. A. Wente et al., “Manufacture of Superfine Organic Fibers”, Navy Research Laboratory, Washington, D.C., NRL Report 4364 (111437), dated May 25, 1954, United States Department of Commerce, Office of Technical Services; and Robert R. Buntin and Dwight T. Lohkamp, “Melt Blowing—A One-Step Fabric Process for New Nonwoven Products”, Journal of the Technical Association of the Pulp and Paper Industry, Vol. 56, No.4, pp. 74-77 (1973); coforming references include U.S. Pat. No. 4,100,324 to R. A. Anderson et al. and U.S. Pat. No. 4,118,531 to E. R. Hauser; and spunbonding references include, among others, U.S. Pat. No. 3,341,394 to Kinney, U.S. Pat. No. 3,655,862 to Dorschner et al., U.S. Pat. No. 3,692,618 to Dorschner et al., U.S. Pat. No. 3,705,068 to Dobo et al., U.S. Pat. No. 3,802,817 to Matsuki et al., U.S. Pat. No. 3,853,651 to Porte, U.S. Pat. No. 4,064,605 to Akiyama et al., U.S. Pat. No. 4,091,140 to Harmon, U.S. Pat. No. 4,100,319 to Schwartz, U.S. Pat. No. 4,340,563 to Appel and Morman, U.S. Pat. No. 4,405,297 to Appel and Morman, U.S. Pat. No. 4,434,204 to Hartman et al., U.S. Pat. No. 4,627,811 to Greiser and Wagner, and U.S. Pat. No. 4,644,045 to Fowells.

Other methods for preparing nonwoven fabrics are, of course, known and may be employed. Such methods include air laying, wet laying, carding, and so forth. In some cases it may be either desirable or necessary to stabilize the nonwoven fabric by known means, such as thermal point bonding, through-air bonding, and hydroentangling. In addition to nonwoven fabrics, the hydrophobic polymer fibers may be in the form of continuous filaments or staple fibers, as well as woven or knitted fabrics prepared from such continuous filaments or staple fibers. Furthermore, the nonwoven fabric may include bicomponent or other multicomponent fibers. Exemplary multicomponent nonwoven fabrics are described in U.S. Pat. No. 5,382,400 issued to Pike et al., U.S. patent application Ser. No. 10/037,467 entitled “High Loft Low Density Nonwoven Fabrics Of Crimped Filaments And Methods Of Making Same” and U.S. patent application Ser. No. 10/136,702 entitled “Methods For Making Nonwoven Materials On A Surface Having Surface Features And Nonwoven Materials Having Surface Features” which are hereby incorporated by reference herein in their entirety. Sheath/core bicomponent fibers where the sheath is a polyolefin such as polyethylene or polypropylene and the core is polyester such as poly(ethylene terephthalate) or poly(butylene terephthalate) can also be used to produce carded fabrics or spunbonded fabrics. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention can provide an overall more efficient material for fluid handling and skin dryness purposes.

The term “hydrophobic polymer” is used herein to mean any polymer resistant to wetting, or not readily wet, by water, i.e., having a lack of affinity for water. Examples of hydrophobic polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mol-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly)t-nonafluorobutyl methacrylate); and polyesters, such a poly(ethylene terephthalate) and poly(butylene terephthalate).

The term “polyolefin” is used herein to mean a polymer prepared by the addition polymerization of one or more unsaturated monomers which contain only carbon and hydrogen atoms. Examples of such polyolefins include polyethylene, polypropylene, poly(1-butene), poly(2-butene), poly(1-pentene), poly(2-pentene), poly(3-methyl-1-pentene), poly(4-methyl-1-pentene), and so forth. In addition, such term is meant to include blends of two or more polyolefins and random and block copolymers prepared from two or more different unsaturated monomers. Because of their commercial importance, the most desired polyolefins are polyethylene and polypropylene. The polyolefin may contain additives as is known or customary in the art. For example, the polyolefin may contain pigments, opacifiers, fillers, delustrants, antioxidants, antistatic agents, stabilizers, oxygen scavengers, and so forth.

In one embodiment, the present invention relates to treatment compositions, printed polymeric substrates and methods of improving the adhesion of an ink composition to a hydrophobic substrate that includes: contacting, desirably coating, at least a portion of a hydrophobic substrate with a composition that comprises a polysaccharide, a modified polysaccharide, a derivative of a polysaccharide, or a derivative of a modified polysaccharide; and printing a pattern or other indicia on at least a portion of the portion of the hydrophobic substrate that was contacted and desirably coated with a polysaccharide, a modified polysaccharide, a derivative of a polysaccharide, or a derivative of a modified polysaccharide using an ink composition. The polysaccharide, modified polysaccharide, derivative of a polysaccharide, or derivative of a modified polysaccharide functions as a primer. Although not necessary, the polymeric substrate may also be pretreated prior to contact with the polysaccharide by form example corona, plasma or flame treatment to oxidize the surface of the substrate and generate some polarity on the substrate surface.

The treatment compositions of the present invention include at least one polysaccharide, modified polysaccharide, derivative of a polysaccharide or derivative of a modified polysaccharide and may include combinations thereof. Generally, a polysaccharide is a natural polymer having glucose as repeating units. The polysaccharide may have a plurality of hydrophobic groups and a plurality of hydrophilic groups. The hydrophobic groups may be ═CH— and —CH₂— groups in the polysaccharide backbone. The hydrophobic groups may be adapted to provide an affinity of the polysaccharide for the hydrophobic polymer of which the porous substrate is composed and the hydrophilic groups may be adapted to modify the chemical and/or physical properties of the polysaccharide. Examples of polysaccharides include, but are not limited to, natural gums, such as agar, agarose, carrageenans, furcelleran, alginates, locust bean gum, gum arabic, guar gum, gum konjac, and gum karaya; microbial fermentation products, such as gellan gum, xanthan gum, and dextran gum; cellulose, such as microcrystalline cellulose and high molecular weight water-soluble cellulose and high molecular weight water-soluble cellulose derivatives; and animal products, such as hyaluronic acid, heparin, chitin, and chitosan. Examples of derivatives of polysaccharides include, but are not limited to, carboxymethyl cellulose, hydroxypropyl cellulose, hydroxyethyl cellulose, and ethyl hydroxyethyl cellulose. Suggested examples of commercially available celluloses include the various grades of high purity thermoplastic hydroxypropylcellulose sold by Aqualon Company of Wilmington, Del. under the trademark KLUCEL, including but not limited to KLUCEL E, KLUCEL L, KLUCEL M and KLUCEL G celluloses. These celluloses are soluble in cold water and in many polar organic solvents and solvent mixtures. For example, the cellulose component of the treatment composition can be dissolved in cold water and then one or more organic solvents, such as n-propyl alcohol, can be added to the cellulose in water solution to decrease the drying time of the treatment composition.

The polysaccharide may be or include a modified polysaccharide. A modified polysaccharide also may have a plurality of hydrophobic groups and a plurality of hydrophilic groups. The hydrophobic groups may be ═CH— and —CH₂— groups in the polysaccharide backbone, or pendant groups. The hydrophilic groups also may be pendant groups. The term “pendant” used herein with respect to the hydrophobic or other groups means that such groups are attached to the polymer backbone but are not part of it. Thus, removal of the pendant groups will not alter the chemical structure of the backbone. Again, the hydrophobic groups may be adapted to provide an affinity of the polysaccharide for the hydrophobic polymer of which the porous substrate is composed and the hydrophilic groups may be adapted to render the polysaccharide hydrophilic. By way of illustration only, examples of modified polysaccharides include, but are not limited to, modified celluloses or cellulose derivatives, such as hydroxyethyl cellulose, hydroxypropyl cellulose, methyl cellulose, ethyl cellulose, methyl hydroxypropyl cellulose, ethyl hydroxyethyl cellulose, and carboxymethyl cellulose; starch and pectin derivatives, such as carboxymethyl starch, starch aldehyde, and pectates; and animal product derivatives, such as carboxymethyl chitin and carboxymethyl chitosan.

Suggested polysaccharides and modified polysaccharides include, by way of illustration, include: agar, alginates, and modified celluloses, such as ethyl hydroxyethyl cellulose. In modified polysaccharides, particularly in the useful type of modified polysaccharides just noted, the hydrophobic groups may be pendant monovalent alkyl groups. For example, such hydrophobic groups may be methyl or ethyl groups. As a further example, the hydrophilic groups may be pendant monovalent hydroxyalkyl groups. As yet another example, such hydrophilic groups may be hydroxyethyl groups. Another suggested polysaccharide is an ethyl hydroxyethyl cellulose sold by Akzo Nobel of Strafford, Conn. under the tradename BERMOCOLL EBS E481 FQ. BERMOCOLL EBS E481 FQ is a high molecular weight, water-soluble cellulose derivative. The chemical formula for BERMOCOLL EBS E481 FQ is

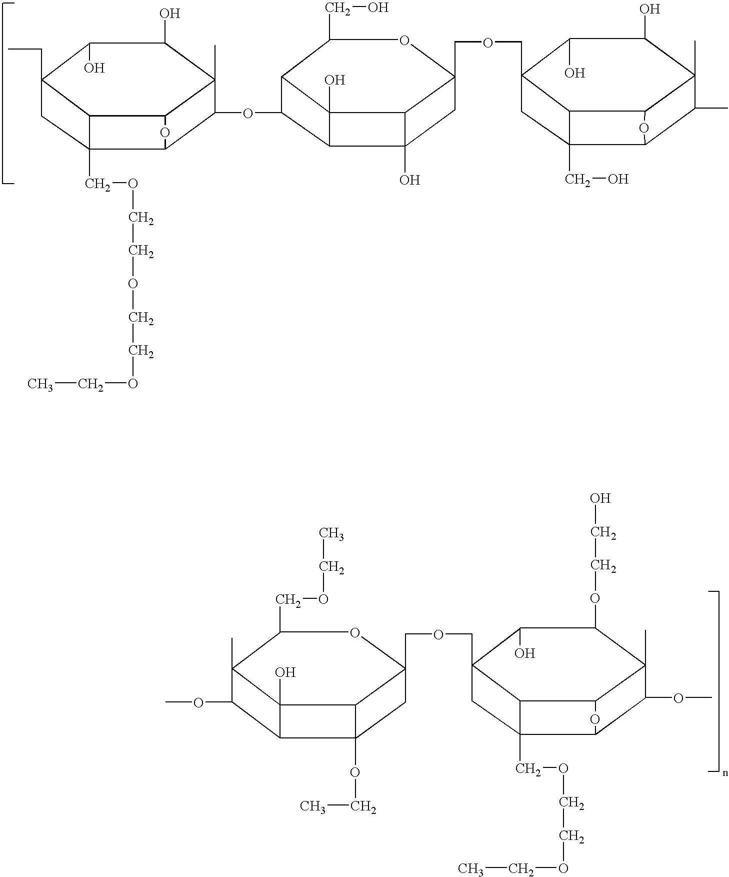

with an average degree of polymerization (n) ranging from 300 to 2600. Other grades of ethyl hydroxyethyl cellulose derivatives are produced by Akzo Nobel and can also be used. One suggested example is BERMOCOLL EHM100.

The placement of the coating or treatment of the polysaccharide, a modified polysaccharide, a derivative of a polysaccharide or a derivative of a modified polysaccharide on the substrate may vary and can be varied in a controlled manner across at least one dimension of a porous substrate. For example, the coating or treatment of polysaccharide, a modified polysaccharide, a derivative of a polysaccharide or a derivative of a modified polysaccharide may be on only one side of a substrate and may only be on a portion of one side of a substrate, for example on a central or other smaller region that is desired to be printed on. Thus, the coating or treatment of a substrate would vary in a controlled manner across the width thereof. Other variations coming within the scope of the present invention will be readily apparent to those having ordinary skill in the art.

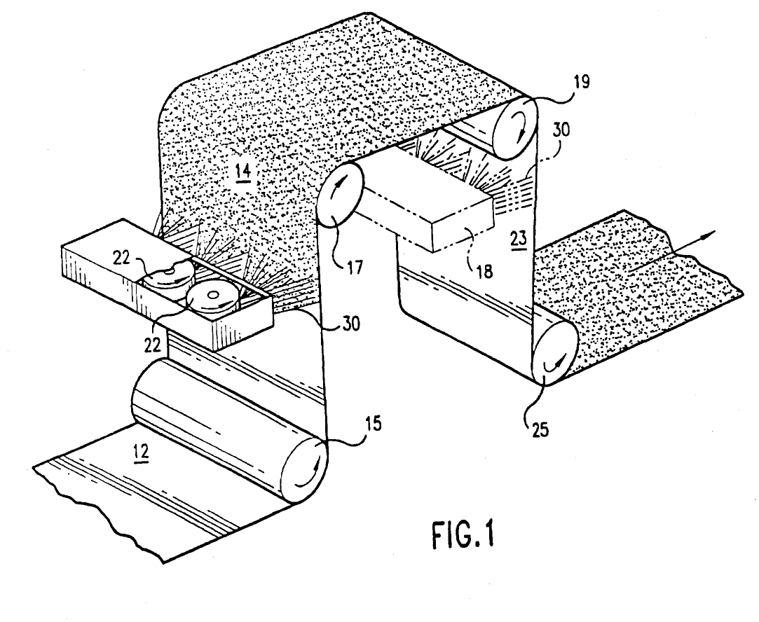

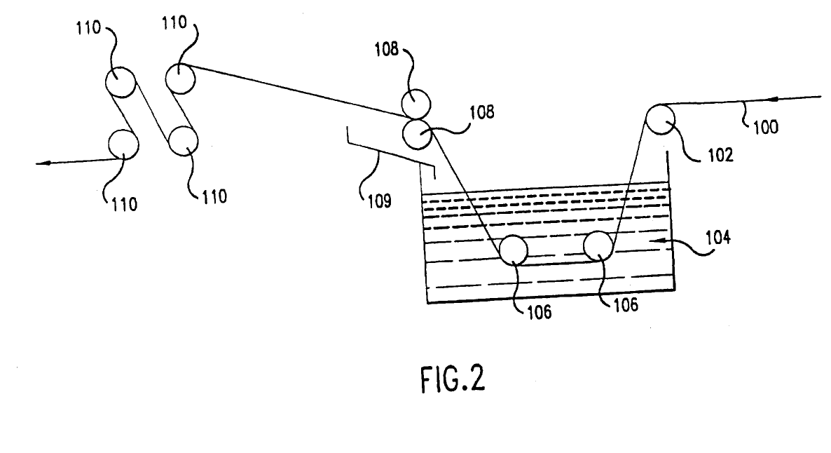

Turning now to an exemplary method for preparing a treated porous substrate, the method involves providing a porous hydrophobic polymer substrate and exposing at least a portion of the substrate to a mixture that includes at least one of a polysaccharide, modified polysaccharide, derivative of a polysaccharide, derivative of a modified polysaccharide or a combination of or that includes any of the previously described polysaccharides. A suggested combination includes contacting the porous substrate with a mixture that includes ethyl hydroxyethyl cellulose. The treatment composition(s) may further include other components, such as wetting agents, emulsifiers, lubricants, anti-stats, skin care ingredients, anti-oxidants, vitamins, botanical extracts, scents, odor control agents, color, and anti-microbials. Exemplary methods of treating a substrate with treatment compositions are provided in the figures where FIG. 1 illustrates a first exemplary process that sprays a treatment composition on a substrate and FIG. 2 illustrates a second, exemplary “dip and squeeze” process of applying a treatment composition to a substrate. Persons of skill in the art would appreciate that other methods of applying treatment compositions such as spraying, printing foaming, or applying the treatment composition with a kiss roll, flexography or by rotogravure can be used with the present invention. In addition, it may be desirable to pretreat the substrate, for example by exposing the substrate with corona or plasma treatment, prior contacting the substrate with the polysaccharide, modified polysaccharide, derivative of a polysaccharide, derivative of a modified polysaccharide.

Referring to FIG. 1, an exemplary process for applying a treatment composition of the present invention to one or both sides of a traveling fabric will be described. It should be appreciated by those skilled in the art that the invention is equally applicable to inline treatment or a separate, offline treatment step. Fabric 12, for example a spunbonded or meltblown nonwoven, is directed under support roll 15 to a treating station including rotary spray heads 22 for application to one side 14 of fabric 12. An optional treating station 18 (shown in phantom) which includes rotary spray heads can also be used to apply the same treatment composition or another treatment composition to opposite side 23 of fabric 12 directed over support rolls 17 and 19. Each treatment station receives a supply of treating liquid 30 from a reservoir (not shown).

Either or both treating stations may include a rotary spray system that applies the treatment composition. An exemplary spray system is illustrated in FIGS. 1, 3 and FIG. 4 illustrates an exemplary rotary spray zoned treatment application apparatus and system. A suggested system and apparatus that includes the components illustrated in the figures includes a “WEKO” system. The WEKO system and apparatus can be obtained from WEKO, Biel AG, Switzerland. The configuration includes a centrifugal damping application system using a single or double rotocarrier. The surfactant formulation is pumped to the header through a gear pump where it is fed to the damping rotors through restrictor tubes. The system is equipped with a series of rotors 50, which spin at a speed of about 4500 rpm. Under the effect of a centrifugal force generated by the spinning rotors 50, a treatment composition can be dispensed to the nonwoven fabric or other substrate 52 in the form of an aerosol or small droplets 54.

Throughput as measured in gram/minute is controlled and adjusted with different diameter restrictor tubes, header pressure and bath parameters (e.g. concentration and temperature). Additionally, finer throughput control can be achieved by adding optional needle valves to the outlet ports of the header. If a zone treatment is desired, templates 60 made of stainless steel or another solid material of a predetermined width are placed in front of the fabric so that the spray is applied to the material only through the template opening(s) 62. A suggested template opening is 4 inches and provides a 4-inch wide treated zone 53 to a nonwoven material 52.

The treated fabric may then be dried if needed by passing over dryer cans (not shown) or other drying means and then under support roll 25 to be wound as a roll or converted to the use for which it is intended. For a polypropylene fabric, drying can be achieved by heating the treated fabric to a temperature from about 220° F. to 300° F., more desirably to a temperature from 270° F. to 290° F., by passage over a heated drum to set the treatment composition and complete drying. Drying temperatures for other polymers will be apparent to those skilled in the art. Alternative drying means include ovens, through air dryers, infrared dryers, air blowers, and so forth.

FIG. 2 illustrates an alternative arrangement and method of applying a treatment composition of the present invention. The process illustrated in FIG. 2 is refereed to as a “dip and squeeze” process. In the dip and squeeze process, the substrate is saturated with a bath containing the treating formulation, typically by immersing the substrate in the bath. The saturated material can then be nipped at a controllable pressure between two rubber rollers to remove excess saturant. Bath concentration, nip pressure and line speed are parameters that control add-on level on the fabric. Add-on level is measured by gravimetric analysis using the following equations 1 and 2.

%Wet Pick Up(WPU)=[(W_{w}−W_{d})/W_{d}]×100 (Equation 1)

and

Wt%Add-on=%WPU×C (Equation 2)

where, WW=Wet weight of the substrate after saturation and nipping (grams)

Wd=Dry weight of treated substrate (grams)

C=bath chemical concentration (wt %)

The nip between squeeze rolls 108 removes excess treating composition which is returned to the bath by catch pan 109. Drying cans 110 remove remaining moisture. If more than one treatment composition is employed, the dip and squeeze may be repeated and the fabric 100 can be forwarded to and immersed in additional baths (not shown). The dried, treated substrate can be printed on by a variety of printing methods.

Suggested printing methods include, but are not limited to, flexographic printing, in jet printing, screen printing, lithographic printing and gravure printing methods. The present invention desirably utilizes a flexographic printing method to provide the proper balance of cost effective, high speed, high quality printing suitable for printing nonwoven fibrous webs, while maintaining the tactile softness of the web. Flexographic printing is a printing technology that is well known. Generally, flexographic printing uses flexible raised rubber or photopolymer plates to carry an image to a given substrate. The flexible plates carry a typically low-viscosity ink directly onto the substrate. Ink compositions for printing are well known. Ink compositions suitable for printing on hydrophobic polyolefin based materials are also known. For example, ink compositions for printing on polyolefin-based nonwoven and film substrates are described in U.S. Pat. No. 5,458,890, which is hereby incorporated by reference herein in their entireties. The ink composition may be a conventional ink formulation. A suggested flexographic ink formulation may, for example, include: 12 parts by weight of an organic pigment, 8 parts by weight of dry nitrocellulose, 14 parts by weight of a plasticizer, 36 parts by weight of N-propanol, 16 parts by weight of ethanol, and about 2 parts by weight of additives. In addition, the ink composition may further include a polysaccharide, a modified polysaccharide, a derivative of a polysaccharide, or a derivative of a modified polysaccharide that may be the same polysaccharide, a modified polysaccharide, a derivative of a polysaccharide, or a derivative of a modified polysaccharide as that of the treatment composition to further improve transfer and/or adhesion of the ink composition to the substrate.

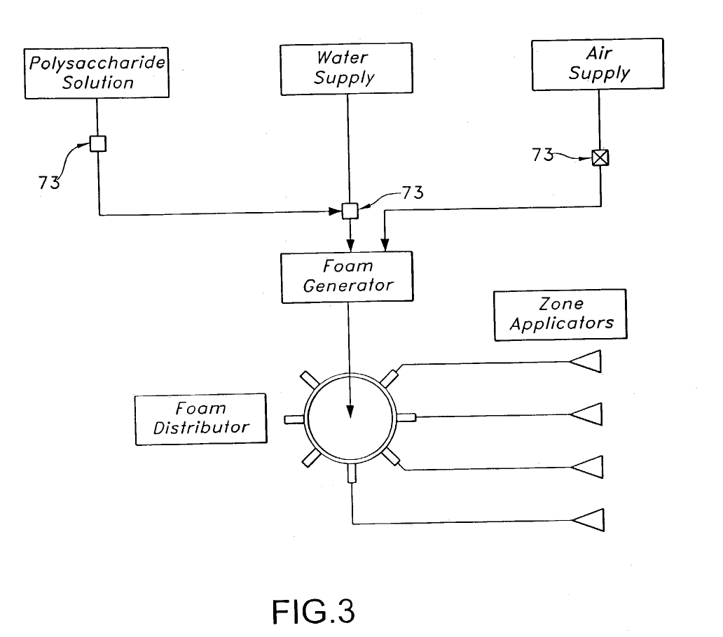

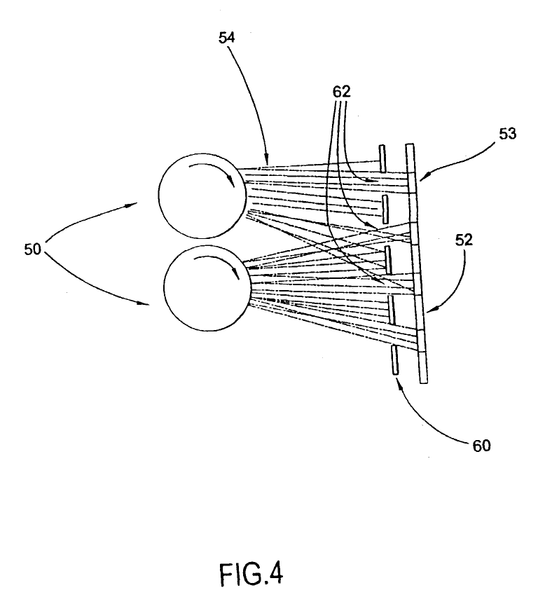

Another process that can be used to apply treatment compositions of the present invention to a substrate includes a foaming process. Foaming is a desirable process because of its efficiency, ease of operation, cleanliness, and good control over process parameters. A general schematic diagram of a foam process is shown in FIG. 3 and includes chemical tanks, air and water supplies, and metering devices (e.g. pumps, valves and flow meters) connected to a high shear-mixing chamber. Suggested foam equipment can be obtained from Gaston Systems, Incorporated of Stanley, N.C. This equipment includes a parabolic foam applicator with a ⅛ inch slot opening and a slot width that is adjustable from about 11 inches to about 18 inches, but can be as wide as 120 inches or more. This kind of foam equipment is capable of full width treatment or zone treatment. The zone treatment is achieved by using foam applicator of a specific width, e.g. 4 inches wide. In the case of zone treatment multiple 4 inch wide foam applicators can be used to simultaneously treat multiple slits of a nonwoven base roll as illustrated in FIGS. 3 and 4. Various other methods may be employed for contacting a substrate with the treatment composition or compositions in accordance with the invention. For example, a substrate may be printed on by means of print rolls, slot coating or other conventional coating techniques.

In a desirable embodiment, a nonwoven fabric or a portion of a nonwoven fabric is treated according to a method of the present invention wherein the nonwoven fabric is contacted with a composition that includes at least one polysaccharide, modified polysaccharide, derivative of a polysaccharide, or derivative of a modified polysaccharide in order to improve the adhesion and retention of an ink composition to the nonwoven fabric. The treated portion of the nonwoven fabric may then be printed with an ink composition. Alternatively, a nonwoven fabric can be formed with treated fibers. The treated nonwoven fabric can be incorporated into a personal care product, such as an outercover of a diaper or other personal care product, to provide printed or printable product such a diaper having a printed character on the front portion of the outercover of the diaper. Treated nonwoven fabrics of the present invention may vary in basis weight and/or density and may be applicable to a variety of applications including, but not limited to, components of various personal care and absorbent products, for example diapers, swimming pants, training pants, surgical drapes, medical garments, wipers such as infant wipers and clean room wipers, and so forth.

The treated nonwoven fabric can be printed by a variety of know printing methods including, but not limited to, flexographic and rotogravure printing methods. Although flexographic printing is suggested, other printing processes and apparatus or combinations thereof are also contemplated by the present invention. These other printing processes include screen printing, rotogravure printing in which an engraved print roll is utilized, and ink jet printing in which nozzles spray ink droplets that are selectively deflected by an electrostatic charge to form the desired pattern on the substrate. The ink selection and formulation can vary and the selection and testing of various inks is within the skill of a person of skill in the art. Ink compositions containing organic solvents which evaporate and dry quickly are suggested as well as nitrocellulose inks.

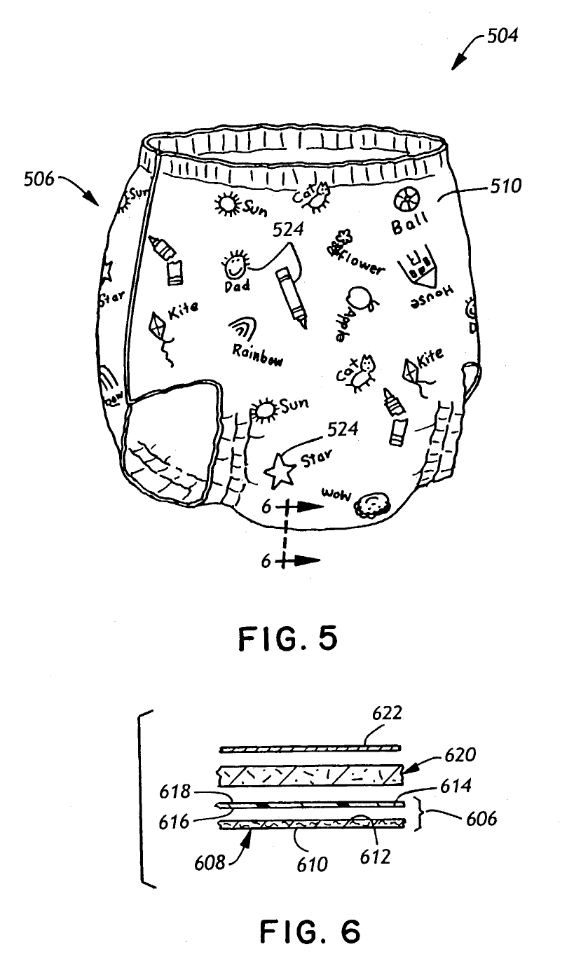

An exemplary printed substrate is included in the illustrated in FIGS. 5 and 6, where FIG. 5 is perspective view of an exemplary training pant and FIG. 6 is an exploded cross-sectional view of FIG. 5 taken along line 6-6. The illustrated exemplary printed substrate is a backsheet 506 of a training pant 504 but could be a printed surface on any of a variety of absorbent articles absorbent upon which printed information or designs might be desirable including, but not limited to, diapers, feminine care products, incontinence products, training pants, swimming pants, wipes, protective garments, medical apparel, and so forth. These and other articles that include hydrophobic substrates upon which printing is desired are well known.

One way to make these products more appealing is to print in bright colors on the products. For example, in FIGS. 5 and 6, training pant 504 comprises a backsheet 506, which can be a two-layered laminate that includes a nonwoven polyolefin fibrous web 608 suitably joined to a liquid impervious film 614. Web 608 has opposed surfaces such as inner surface 612 and outer visible surface 510. Film 614 has opposed surfaces such as surface 616 that faces toward web inner surface 612 and surface 618 that faces toward absorbent composite 620. A liquid permeable topsheet 622 is positioned on the side of absorbent composite 520 opposite to backsheet 506, and is the layer that is against the skin of the wearer. It is outer visible surface 510 of nonwoven polyolefin fibrous web 508 that presents or forms the outermost, visible surface of training pant 504 and on which images 524 are printed. A number of intricate, registered images on the outer visible surface of the backsheet or outer cover; by outer “visible” surface is meant that surface of the product that is visible when the product is worn.

Topsheet 622 can be made of any suitable liquid permeable material, and absorbent composite 620 can be made of any suitable absorbent materials appropriate for the intended use of the particular product. If desired, backsheet 506 can comprise only a liquid permeable layer, such as nonwoven polyolefin fibrous web 508, or can comprise a two-layered laminate as described above. More detailed descriptions of a training pant can be found in U.S. Pat. No. 4,940,464, the entire contents of which are hereby incorporated by reference herein. The colored images may be printed on an underlying layer, such as a film layer, or on the outermost layer, such as a nonwoven layer. For example, with reference to FIG. 6, images 524 can be printed on inner surface 612 of web 608, surface 616 of film 614, surface 618 of film 614, or another surface.

Yet another exemplary method of treating a surface is illustrated in FIGS. 7 and 8. FIG. 7 schematically illustrates a flexographic printing method that includes a treatment step in accordance with the present invention. FIG. 8 is an enlarged view of an exemplary printing station 710 that may be used to apply a treatment composition of the present invention on a substrate 705. In one embodiment, a first treatment/printing station 720 is used to apply a treatment composition of the present invention. A substrate 705 is forwarded to drum 700 so that the substrate 705 is conveyed to printing stations 720 and 740. The printing stations 740 may be used to apply inks of varying colors, for example, magenta, cyan, green and so forth. Dryers may be inserted and employed between printing stations. Each station 710 or 740 includes a printing roll 710 that may include a raised pattern or, in some instances, a flat surface to transfer an ink composition and, in one desirable embodiment, a treatment composition at the first station 720 on to the substrate 705. Each station includes metering rolls 712 and a tray 716 to supply and transfer a composition, ink or treatment composition, to the printing roll 710.

The present invention is further illustrated by the following examples which are representative of the invention although other examples will be apparent to those skilled in the art and are intended to be covered by the claims.

### EXAMPLES

Treatment compositions were prepared as follows:

3.0 weight percent KLUCEL E hydroxypropylcellulose treatment solution A first treatment solution consisting of about 97 weight percent of 1-propanol and about 3.0 weight percent of KLUCEL E hydroxypropylcellulose was prepared by combining 13.2 kilograms of n-propanol solvent and 407 grams of KLUCEL E cellulose derivative and mixing them for approximately 5 minutes using a Ross High Shear Mixer. The treatment solution was then mixed moderately for about an additional 5 minutes using an impeller mixer. The solution was covered and left overnight. No settling of the KLUCEL E cellulose derivative in the treatment solution was observed. The KLUCEL E cellulose derivative was obtained from Aqualon Company a division of Hercules Inc., of Wilmington, Del.

1.0 Weight Percent KLUCEL E Hydroxypropylcellulose Treatment Solution

A second treatment solution consisting of about 97 weight percent of 1-propanol and about 1.0 weight percent of KLUCEL E hydroxypropylcellulose was prepared by combining 13.1 kilograms of n-propanol solvent and 132 grams of KLUCEL E cellulose derivative and mixing them for approximately 5 minutes using a Ross High Shear Mixer. The treatment solution was then mixed moderately for about an additional 5 minutes using an impeller mixer. The solution was covered and left overnight. No settling of the KLUCEL E cellulose derivative in the treatment solution was observed.

3.0 Weight Percent KLUCEL L Hydroxypropylcellulose Treatment Solution

A third treatment solution consisting of about 97 weight percent of 1-propanol and about 3.0 weight percent of KLUCEL L hydroxypropylcellulose was prepared by combining 12.7 kilograms of n-propanol solvent and 393 grams of KLUCEL L cellulose derivative and mixing them for approximately 5 minutes using a Ross High Shear Mixer. The treatment solution was then mixed moderately for about an additional 5 minutes using an impeller mixer. The solution was covered and left overnight. No settling of the KLUCEL L cellulose derivative in the treatment solution was observed. The KLUCEL L cellulose derivative was also obtained from Aqualon Company a division of Hercules Inc., of Wilmington, Del.

1.0 Weight Percent KLUCEL L Hydroxypropylcellulose Treatment Solution

A fourth treatment solution consisting of about 97 weight percent of 1-propanol and about 1.0 weight percent of KLUCEL L hydroxypropylcellulose was prepared by combining 13.6 kilograms of n-propanol solvent and 139 grams of KLUCEL E cellulose derivative and mixing them for approximately 5 minutes using a Ross High Shear Mixer. The treatment solution was then mixed moderately for about an additional 5 minutes using an impeller mixer. The solution was covered and left overnight. No settling of the KLUCEL E cellulose derivative in the treatment solution was observed.

0.5 Weight Percent BERMOCOLL EBS E481 FQ Ethyl Hydroxyethyl Cellulose Derivative

A fifth treatment solution including about 0.5 weight percent of BERMOCOLL EBS E481 FQ ethyl hydroxyethyl cellulose (EHEC) derivative was prepared by combining 12,186 grams n-propanol, 1354 grams water and 68 grams EHEC to form a 1.0 solution of EHEC in a 90:10 n-propanol and water solution. First, the 1354 grams water and an approximately equal volume of n-propanol were combined and blended. Next, 136 grams of BERMOCOLL EBS E481 FQ EHEC was added to the water/n-propanol mixture under high shear from a Ross High Shear mixer. The three components were mixed for 5 minutes to form a solution. Next, the remaining n-propanol was slowly added to the solution under moderate mixing with an impeller to complete the solution. The EBS E481 FQ ethyl hydroxyethyl cellulose derivative was obtained from Akzo Nobel Inc., of Strafford, Conn.

Printed Samples

Samples of a 0.8 ounce per square yard (osy) polypropylene spunbonded nonwoven fabric were treated with the various treatment solutions by saturating a sample of nonwoven fabric with a treatment solution using an Atlas lab wringer. The saturated nonwoven fabric samples were dried for about 2 minutes at about 75° C. The treated samples were then printed using a flexographic printing method with a PYROFLEX flexographic ink formulation. Specifically, 0.75-inch by 4.5-inch rectangles were printed on the surface of the sample materials. The overall print coverage of the samples was about 28 percent. These printed samples were tested for ink adhesion using the test method described above. A minimum crockfasteness of 3.5 is desired.

Three nonwoven samples were not treated with a treatment formulation prior to printing to provide comparative examples. And, some of the examples were pretreated with corona treatment at line speed of 250 fpm and 9 kilowatts before contact with a treatment solution. The printed samples and their respective crockfastness numbers (CFN) are as follows:

Comparative Ex. A—printed w/ PYROFLEX ink, no treatment—CFN 2.80.

Comparative Ex. B—printed w/ PYROFLEX ink, corona treatment—CFN 2.92.

Example 1—treated w/0.5% EHEC and printed w/ PYROFLEX ink—CFN 2.34.

Example 2—corona treated and 0.5% EHEC, printed w/ PYROFLEX ink—CFN 2.58.

Example 3—treated w/1% KLUCEL E and printed w/ PYROFLEX ink—CFN 3.58.

Example 4—corona treated and 1% KLUCEL E, printed w/ PYROFLEX ink—CFN 3.28.

Example 5—treated w/1% KLUCEL L and printed w/ PYROFLEX ink—CFN 3.17.

Example 6—corona treated and w/1% KLUCEL L, printed w/ PYROFLEX ink—CFN 3.28.

Example 7—treated w/3% KLUCEL E and printed w/ PYROFLEX ink—CFN 3.59.

Example 8—corona treated and 3% KLUCEL E, printed w/ PYROFLEX ink—CFN 3.87.

Example 9—treated w/3% KLUCEL L and printed w/ PYROFLEX ink—CFN 3.29.

Example 10—corona treated and 3% KLUCEL L, printed w/ PYROFLEX ink—CFN 3.57.

The following two samples were tested using a “wet crockfastness test” that was conducted by saturating the printed samples with saline before rubbing the printed sample to determine the resistance of the printed sample to saline (urine). The wet crockfastness test is an indication of a printed sample's adhesion in wet conditions and the sample's ability to resist abrasion if a training pant or diaper leaked.

Comparative Ex. C—printed w/ PYROFLEX ink (wet crockfastness test)—CFN 3.98.

Example 11—corona treated and 0.5% EHEC, printed w/ PYROFLEX ink (wet crockfastness test)—CFN 2.58.

Thus, in accordance with the invention, there has been provided printed substrates, for example nonwoven fabrics, films, and foams and methods of improving the adhesion of an ink composition to a hydrophobic substrate. While the invention has been illustrated by specific embodiments, it is not limited thereto and is intended to cover all equivalents as come within the broad scope of the claims.

We claim:

1. A printed polymeric substrate comprising:
a polymeric substrate;
a coating or other surface treatment on at least a portion of the polymeric substrate, the coating comprising at least one of a polysaccharide, a modified polysaccharide, a derivative of a polysaccharide, or a derivative of a modified polysaccharide; and
a pattern or other indicia comprising an ink composition printed on at least a portion of the portion of the polymeric substrate that is coated with at least one of a polysaccharide, a modified polysaccharide, a derivative of a polysaccharide, or a derivative of a modified polysaccharide.

2. The printed polymeric substrate of claim 1 wherein polymeric substrate is hydrophobic.

3. The printed polymeric substrate of claim 1 wherein polymeric substrate is a nonwoven, a film or a foam.

4. The printed polymeric substrate of claim 1 wherein the polymeric substrate comprises hydrophobic fibers.

5. The printed polymeric substrate of claim 1 wherein the polymeric substrate is a nonwoven fabric that comprises fibers that comprise a polyolefin.

6. The printed polymeric substrate of claim 5 wherein the printed polymer substrate forms or is a component of a protective garment, a medical apparel article, a diaper, a training pant, or a swimming pant.

7. The printed polymeric substrate of claim 1 wherein the polysaccharide, the modified polysaccharide, the derivative of a polysaccharide, and the derivative of a modified polysaccharide are a selected from the group consisting of cellulosics, modified cellulose ethers and modified cellulose esters.

8. The printed polymeric substrate of claim 1 wherein the polysaccharide, the modified polysaccharide, the derivative of a polysaccharide, and the derivative of a modified polysaccharide are selected from the group consisting of carboxymethyl cellulose, hydroxypropyl cellulose, methylhydroxypropyl cellulose, hydroxyethyl cellulose, methylhydroxyethyl cellulose, and ethylhydroxyethyl cellulose.

9. The printed polymeric substrate of claim 1 wherein the polysaccharide, the modified polysaccharide, the derivative of a polysaccharide, and the derivative of a modified polysaccharide is hydroxypropyl cellulose, methylhydroxypropyl cellulose or ethylhydroxyethyl cellulose.

10. The printed polymeric substrate of claim 1 wherein the ink composition comprises a polysaccharide, a modified polysaccharide, a derivative of a polysaccharide, or a derivative of a modified polysaccharide.

11. The printed polymeric substrate of claim 1 wherein the ink composition comprises the polysaccharide, the modified polysaccharide, the derivative of a polysaccharide, or the derivative of a modified polysaccharide of the coating or other surface treatment that is on at least a portion of the polymeric substrate.

12. The printed polymeric substrate of claim 8 wherein the ink composition comprises carboxymethyl cellulose, hydroxypropyl cellulose, methylhydroxypropyl cellulose, hydroxyethyl cellulose, methylhydroxyethyl cellulose, or ethylhydroxyethyl cellulose.

13. The printed polymeric substrate of claim 8 wherein the ink composition comprises hydroxypropyl cellulose or ethylhydroxyethyl cellulose.

14. The printed polymeric substrate of claim 10 wherein the ink composition comprises less than 50 weight percent of water.

15. The printed polymeric substrate of claim 10 wherein the ink composition is a non-aqueous ink composition that further comprises methanol, ethanol, 1-propanol, 2-propanol, 1-butanol, 2-butanol or another alcohol.

16. The printed polymeric substrate of claim 1 wherein the polysaccharide, the modified polysaccharide, the derivative of a polysaccharide, or the derivative of a modified polysaccharide is hydroxypropyl cellulose or ethylhydroxyethyl cellulose and the ink composition is a nitrocellulosic ink that comprises hydroxypropyl cellulose or ethylhydroxyethyl cellulose.

17. A method of improving the adhesion of an ink composition to a hydrophobic substrate, the method comprising:
contacting at least a portion of a hydrophobic substrate with a composition that comprises a polysaccharide, a modified polysaccharide, a derivative of a polysaccharide, or a derivative of a modified polysaccharide; and
printing a pattern or other indicia on at least a portion of the portion of the hydrophobic substrate that was contacted with a polysaccharide, a modified polysaccharide, a derivative of a polysaccharide, or a derivative of a modified polysaccharide using an ink composition.

18. The method of claim 17 wherein the treatment composition further comprises water.

19. The method of claim 17 wherein the treatment composition further comprises an alcohol.

20. The method of claim 17 wherein the treatment composition comprises less than about 1 percent by weight of a polysaccharide, a modified polysaccharide, a derivative of a polysaccharide, a derivative of a modified polysaccharide or a combination thereof relative to the weight of the treatment composition.

21. The method of claim 17 wherein the treatment composition comprises less than about 0.5 percent by weight of a polysaccharide, a modified polysaccharide, a derivative of a polysaccharide, a derivative of a modified polysaccharide or a mixture thereof relative to the weight of the treatment composition.

22. The method of claim 17 wherein the treatment composition comprises less than about 0.3 percent by weight of a polysaccharide, a modified polysaccharide, a derivative of a polysaccharide, a derivative of a modified polysaccharide or a mixture thereof relative to the weight of the coating composition.

23. The method of claim 17 further comprising exposing the hydrophobic substrate to corona discharge, plasma or flame treatment prior to contacting the substrate with a polysaccharide, a modified polysaccharide, a derivative of a polysaccharide, or a derivative of a modified polysaccharide.

24. The method of claim 17 wherein polymeric substrate is a hydrophobic film, foam or nonwoven substrate.

25. The method of claim 17 wherein the polymeric substrate comprises a spunbonded nonwoven fabric.

26. The method of claim 17 wherein the polysaccharide, the modified polysaccharide, the derivative of a polysaccharide, or the derivative of a modified polysaccharide is selected from the group consisting of a cellulosic, a modified cellulose ether and a modified cellulose ester.

27. The method of claim 17 wherein the polysaccharide, the modified polysaccharide, the derivative of a polysaccharide, or the derivative of a modified polysaccharide is selected from the group consisting of carboxymethyl cellulose, hydroxypropyl cellulose, methylhydroxypropyl cellulose, hydroxyethyl cellulose, methylhydroxyethyl cellulose, and ethylhydroxyethyl cellulose.

28. The method of claim 17 wherein the ink composition comprises a polysaccharide, a modified polysaccharide, a derivative of a polysaccharide, or a derivative of a modified polysaccharide.

29. The method of claim 17 wherein the ink composition comprises carboxymethyl cellulose, hydroxypropyl cellulose, methylhydroxypropyl cellulose, hydroxyethyl cellulose, methylhydroxyethyl cellulose, or ethylhydroxyethyl cellulose.

30. The method of claim 17 wherein the polysaccharide, the modified polysaccharide, the derivative of a polysaccharide, or the derivative of a modified polysaccharide is hydroxypropyl cellulose or ethylhydroxyethyl cellulose; and
the ink composition comprises hydroxypropyl cellulose or ethylhydroxyethyl cellulose.

31. The method of claim 17 wherein the ink composition comprises less than 50 weight percent of water.

32. The method of claim 17 wherein the ink composition is a non-aqueous ink composition that comprises an alcohol.

33. The method of claim 17 wherein the ink composition is a non-aqueous ink composition that comprises greater than 30 percent by weight of methanol, ethanol, 1-propanol, 2-propanol, 1-butanol, or 2-butanol.

34. A method of improving the adhesion of an ink composition to a hydrophobic, spunbonded nonwoven substrate, the method comprising:
forming a hydrophobic, spunbonded nonwoven substrate;
contacting at least a portion of the hydrophobic, spunbonded nonwoven substrate with a treatment composition that comprises an alcohol and less than about 1.0 weight percent of a polysaccharide, a modified polysaccharide, a derivative of a polysaccharide, or a derivative of a modified polysaccharide; and
printing a pattern or other indicia on at least a portion of the portion of the hydrophobic, spunbonded nonwoven substrate that was contacted with a polysaccharide, a modified polysaccharide, a derivative of a polysaccharide, or a derivative of a modified polysaccharide.

35. The method of claim 34 wherein the polysaccharide, the modified polysaccharide, the derivative of a polysaccharide, or the derivative of a modified polysaccharide is selected from the group consisting of carboxymethyl cellulose, hydroxypropyl cellulose, methylhydroxypropyl cellulose, hydroxyethyl cellulose, methylhydroxyethyl cellulose, and ethylhydroxyethyl cellulose.

36. The method of claim 34 wherein the polysaccharide, the modified polysaccharide, the derivative of a polysaccharide, or the derivative of a modified polysaccharide is hydroxypropyl cellulose or ethylhydroxyethyl cellulose and the ink composition comprises hydroxypropyl cellulose or ethylhydroxyethyl cellulose.

37. The method of claim 34 wherein the ink composition comprises less than 50 weight percent of water.

38. The method of claim 34 wherein the ink composition comprises less than about 0.5 weight percent of water.

39. The method of claim 34 wherein the printing is flexographic printing.
